(19) United States
(12) Patent Application Publication
(10) Pub. No.: US 2024/0062085 A1
(43) Pub. Date: Feb. 22, 2024

(54) METHOD, SYSTEM, STORAGE MEDIUM AND DEVICE FOR EVALUATING ADAPTIVE REUSE OF EXISTING RESIDENTIAL BUILDINGS

(71) Applicant: SOUTHEAST UNIVERSITY, Jiangsu (CN)

(72) Inventors: Yuchen HAN, Jiangsu (CN); Dongqing HAN, Jiangsu (CN); Yacheng SONG, Jiangsu (CN); Chuncheng ZHANG, Jiangsu (CN)

(73) Assignee: SOUTHEAST UNIVERSITY, Jiangsu (CN)

(21) Appl. No.: 18/470,416

(22) Filed: Sep. 19, 2023

Related U.S. Application Data
(63) Continuation of application No. PCT/CN2023/081126, filed on Mar. 13, 2023.

(30) Foreign Application Priority Data
Aug. 17, 2022 (CN) 202210985593.6

(51) Int. Cl. G06N 7/00

(52) U.S. Cl. CPC G06N 7/00

(57) ABSTRACT

The present invention discloses a method, system, storage medium and device for evaluating adaptive reuse of existing residential buildings. The method includes: substituting the research data of a to-be-evaluated residential building into an adaptability evaluation system to obtain an evaluation result, and determining a reuse mode of the to-be-evaluated residential building at a region position of a reuse mode decision-making matrix according to the evaluation result; the research data includes current quality data and reuse value data; each region of the reuse mode decision-making matrix corresponds to one reuse mode for existing residential buildings. According to the present invention, adaptability index data of the existing residential buildings are extracted through sample analysis based on a mathematical model, so that the evaluation value of the adaptability is obtained, and the most suitable reuse mode is determined by means of the reuse mode matrix.

### CROSS-REFERENCE TO RELATED APPLICATION

This application is a continuation of international application of PCT application serial no. PCT/CN2023/081126, filed on Mar. 13, 2023, which claims the priority benefit of China application no. 202210985593.6, filed on Aug. 17, 2022. The entirety of each of the above mentioned patent applications is hereby incorporated by reference herein and made a part of this specification.

### TECHNICAL FIELD

The present invention relates to the field of architectural design, and particularly relates to a method, system and device for evaluating adaptive reuse of existing residential buildings.

### RELATED ART

Stock renewal is one of the ways of urban construction. Adaptability is an important indicator of stock renewal, referring to the capability that buildings adapt to changes. Adaptability enables to meet the continuous development needs of users with the least resource consumption and waste discharge, thereby prolonging the service life of a building.

The index system for adaptability evaluation of existing buildings is too complex, and the types of reuse decision-making are unclear. Therefore, on the basis of scientifically measuring the value of reuse and the difficulty of changing status quo, the present invention provides a method for evaluating adaptive reuse of existing residential buildings. The existing residential buildings mentioned in the present invention refer to the existing residential buildings with Chinese traditional characteristics, which are different from Western modernism.

### SUMMARY OF INVENTION

To overcome defects in the prior art, the present invention provides a method for evaluating adaptive reuse of existing residential buildings. The method can be used to evaluate the adaptability of residential buildings by weighing the cost and value, and can associate adaptive evaluation results with a reuse mode decision-making matrix to obtain the optimal reuse mode.

The objective of the present invention can be achieved through the following technical solution.

A method for evaluating adaptive reuse of existing residential buildings, including:
substituting the research data of a to-be-evaluated residential building into an adaptability evaluation system to obtain an evaluation result, and determining a reuse mode of the to-be-evaluated residential building at a region position of a reuse mode decision-making matrix according to the evaluation result;
wherein the research data of the to-be-evaluated residential building includes the data of current quality and reuse value;
the adaptability evaluation system is: xₚ=s_{P1}+s_{P2}, yₚ=s_{P3}+s_{P4};

$${s}_{P 1} = {\sum }_{i = 1}^{5} {s}_{P l i} \cdot {W}_{P l i} , {s}_{P 2} = {\sum }_{i = 1}^{6} {s}_{P 2 i} \cdot {W}_{P 2 i} , {s}_{P 3} = {\sum }_{i = 1}^{3} {s}_{P 3 i} \cdot {W}_{P 3 i} , {s}_{P 4} = {\sum }_{i = 1}^{3} {s}_{P 4 i} \cdot {W}_{P 4 i} ,$$

where xₚ denotes the current quality data of a sample P; yₚ refers to the reuse value data of the sample P; s_{P1} is the maintenance status data of the sample P; s_{P2} is the structure status data of the sample P; s_{P3} is the historical and regional value data of the sample P; s_{P4} is the activation utilization value data of the sample P; s_{P1i} is the absolute value of a maintenance status evaluation factor with the serial number i, W_{P1i} is the weight value of the maintenance status evaluation factor with the serial number i; s_{P2i} is the absolute value of a structure status evaluation factor with the serial number i, W_{P2i} is the weight value of the structure status evaluation factor with the serial number i; s_{P3i} is the absolute value of a historical and regional value evaluation factor with the serial number i, W_{P3i} is the weight value of the historical and regional value evaluation factor with the serial number i; s_{P4i} is the absolute value of an adaptive reuse value evaluation factor with the serial number i, and W_{P4i} is the weight value of the adaptive reuse value evaluation factor with the serial number i; and
each region of the reuse mode decision-making matrix corresponds to one reuse mode for the existing residential buildings; reuse modes at least include a structure retention mode, a structure deformation mode, a component recombination mode, a material regeneration mode, and a demolition mode.

Further, the current quality data includes the data of structural quality and maintenance quality; and the reuse value data includes historical and regional value data and adaptive reuse value data.

Further, in construction of the reuse mode decision-making matrix,
x-axis shows the current quality data, and y-axis shows the reuse value data; the x-axis and the y-axis include low, medium and high sections;
the reuse mode of a section region, corresponds to a low section of the x-axis and a low section of the y-axis, is the demolition mode;
   the reuse mode of a section region, corresponds to the low section of the x-axis and a medium section of the y-axis, is the material regeneration mode;
   the reuse mode of a section region, corresponds to a medium section of the x-axis and the low section of the y-axis, is the component recombination mode;
   the reuse mode of each of following section regions, including a section region corresponds to the medium section of the x-axis and the medium section of the y-axis, a section region corresponds to a high section of the x-axis and the low section of the y-axis, a section region corresponds to the high section of the x-axis and the medium section of the y-axis, a section region corresponds to the low section of the x-axis and a high section of the y-axis, and a section region corresponds to the medium section of the x-axis and the high section, is the structure deformation mode; and
the reuse mode of a section region, corresponds to the high section of the x-axis and the high section of the y-axis, is the structure retention mode.

The present invention further provides a system for evaluating adaptive reuse of existing residential buildings, and the system includes the following modules:
an adaptability evaluation module: an adaptability evaluation system is established based on the analytic hierarchy process, with the current quality data and reuse value data as indicators, and the evaluation result of evaluating the to-be-evaluated residential building is outputted;
a reuse mode decision-making matrix module: the reuse mode decision-making matrix is formed by the intersection of reuse value data and current quality data, and each region of the reuse mode decision-making matrix corresponds to a reuse mode of existing residential buildings; and
a decision-making module: the region of the evaluation result in the reuse mode decision-making matrix, and the reuse mode for the to-be-evaluated residential building are determined.

Further, the current quality data includes the data of structural quality and maintenance quality; and the reuse value data includes historical and regional value data and activation utilization value data.

Further, reuse modes for existing residential buildings include the structure retention mode, the structure deformation mode, the component recombination mode, the material regeneration mode, and the demolition mode.

Further, in construction of the reuse mode decision-making matrix,
x-axis shows the current quality data, and y-axis shows the reuse value data; the x-axis and the y-axis include low, medium and high sections;
the reuse mode of a section region, corresponds to a low section of the x-axis and a low section of the y-axis, is the demolition mode;
   the reuse mode of a section region, corresponds to the low section of the x-axis and a medium section of the y-axis, is the material regeneration mode;
   the reuse mode of a section region, corresponds to a medium section of the x-axis and the low section of the y-axis, is the component recombination mode;
   the reuse mode of each of following section regions, including a section region corresponds to the medium section of the x-axis and the medium section of the y-axis, a section region corresponds to a high section of the x-axis and the low section of the y-axis, a section region corresponds to the high section of the x-axis and the medium section of the y-axis, a section region corresponds to the low section of the x-axis and a high section of the y-axis, and a section region corresponds to the medium section of the x-axis and the high section, is the structure deformation mode; and
the reuse mode of a section region, corresponds to the high section of the x-axis and the high section of the y-axis, is the structure retention mode.

The present invention further provides a storage medium on which a computer program is stored, where when the computer program is executed by a processor, the method for evaluating adaptive reuse of existing residential buildings according to any one of items above is implemented.

The present invention further provides a device for evaluating adaptive reuse of existing residential buildings, and the device includes:
at least one memory, configured for storing a program; and
at least one processor, configured to load the program to implement the method for evaluating adaptive reuse of existing residential buildings according to any one of items above.

The present invention has the following beneficial effects:

The present invention provides a universal quantitative tool for adaptability evaluation and reuse decision-making of existing residential buildings through a matrix model, adaptability index data of the existing residential buildings can be extracted through sample analysis so as to obtain an evaluation value of adaptability, and then the most suitable reuse mode can be deduced from the position of the evaluation value in the matrix; at the same time, the present invention establishes a mechanism for associating the links of adaptability evaluation and reuse mode decision-making of existing residential buildings, and provides a clear guidance for the renovation design of existing residential buildings, which helps to accurately select the reuse strategy so as to achieve the ideal design result.

### BRIEF DESCRIPTION OF DRAWINGS

The present invention will be further described below with reference to the accompanying drawings.

FIG. 1 is a structural diagram of a method for evaluating adaptive reuse of existing residential buildings.

FIG. 2 shows an adaptability evaluation index system.

FIG. 3 shows a reuse mode decision-making matrix.

FIGS. 4A to 4G show adaptability evaluation results of 48 samples from an urban block according to an embodiment of the present invention.

FIG. 5 shows the positions of the adaptability evaluation results of the 48 samples from an urban block in the reuse mode decision-making matrix according to an embodiment of the present invention.

FIG. 6 shows a reuse mode decision-making conclusion on the 48 samples from an urban block according to an embodiment of the present invention.

### DESCRIPTION OF EMBODIMENTS

The technical solutions in the embodiments of the present invention will be clearly and completely described below in combination with the accompanying drawings in the embodiments of the present invention. Apparently, the embodiments described are merely some rather than all of the embodiments of the present invention. Based on the described embodiments of the present invention, all other embodiments acquired by those of ordinary skill in the art without making creative efforts fall within the protection scope of the present invention.

In the description of the present description, the description of reference terms “one embodiment”, “examples”, “specific examples”, etc. means that specific features, structures, materials or characteristics described in combination with the embodiment or example are included in at least one embodiment or example of the present invention. In the present description, the schematic description of the above terms does not necessarily refer to the same embodiment or example. Moreover, the specific features, structures, materials or characteristics described may be combined in a suitable manner in any one or more embodiments or examples.

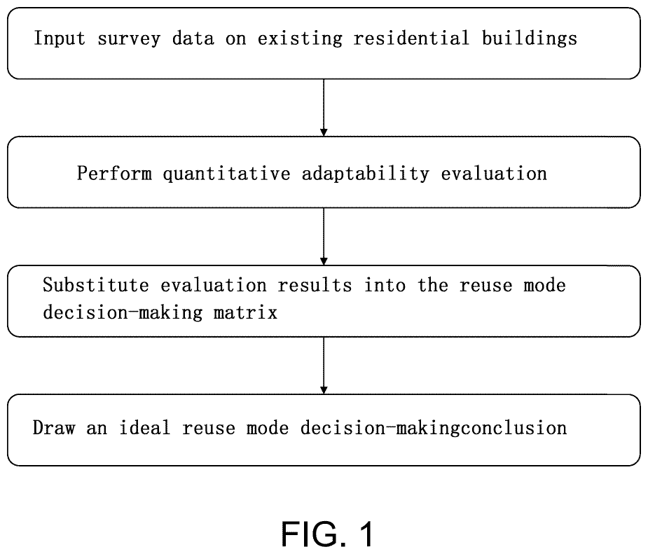

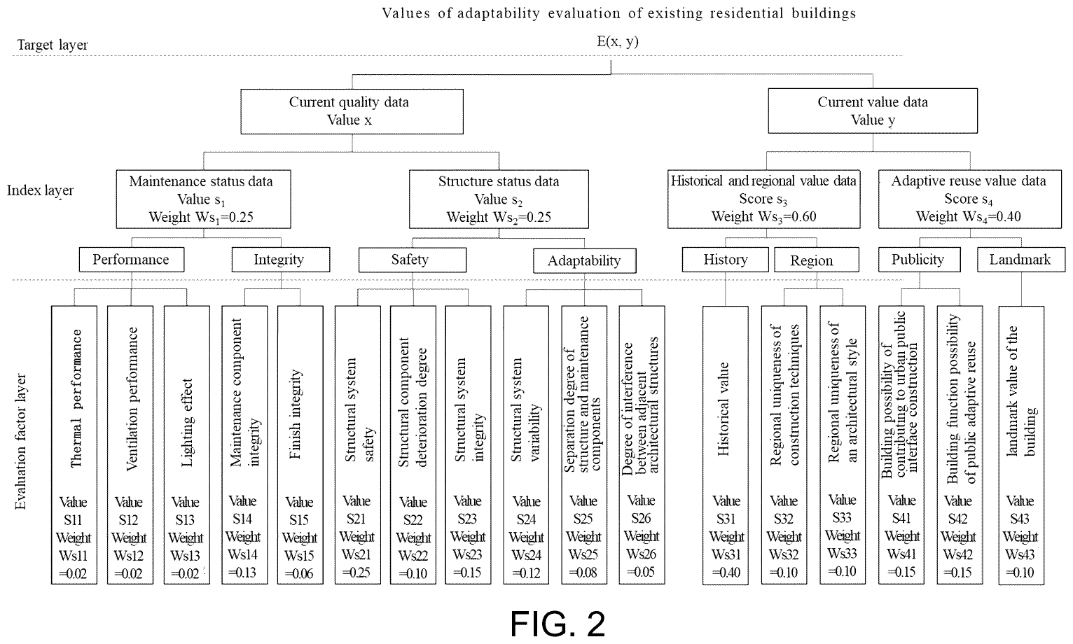

The adaptability of a building, that is, the capability of the building to adapt to changes, is determined by both the current quality and reuse value of the building. The quality in the adaptability of the building directly determines the scientific selection of a reuse method. The present invention provides a method for evaluating adaptive reuse of existing residential buildings, and the method includes the following steps as shown in FIG. 1:
establishing an adaptability evaluation system to realize the quantitative evaluation of building adaptability. As shown in FIG. 2, the evaluation system that affects the building adaptability is divided into a target layer, an index layer, and an evaluation factor layer according to the analytic hierarchy process.

The target layer includes current quality data x and reuse value data y;
in the index layer, the current quality data x includes maintenance status data s₁ and structure status data s₂, and the reuse value data y includes historical and regional value data s₃ and activation utilization value data s₄;
in the evaluation factor layer, the maintenance status data s₁ includes thermal performance s₁₁ (indicating the thermal comfort of an existing building), ventilation performance s₁₂ (indicating the natural ventilation effect of the existing building), lighting effect s₁₃ (indicating the natural lighting effect of the existing building), maintenance component integrity s₁₄ (indicating the integrity of the walls, doors, windows, roofs and other climate boundaries of an enclosed building), and finish integrity s₁₅ (indicating the integrity of a wall surface, a roof surface, and other decorative components of the existing building); the structure status data s₂ includes structural system safety s₂₁ (indicating the safety of an overall structure selection system of the existing building, for example, the safety of a frame structure is stronger than that of a brick-concrete structure), structural component deterioration degree s₂₂ (indicating the degree of performance degradation of structural components of the existing building), structural system integrity s₂₃ (indicating whether the structural system of the existing building has been partially damaged due to renovation or addition), structural system variability s₂₄ (indicating whether the structural system of the existing building is easily transformed, for example, the frame structure is easily transformed than a masonry structure), separation degree s₂₅ of structure and maintenance components (indicating whether the structural and maintenance components of the building are independent of and do not interfere with each other, for example, structural and maintenance components of the brick-concrete structure are integrated, while structural and maintenance components of the frame structure are separated), and degree s₂₆ of interference between adjacent architectural structures (indicating whether the difficulty of reuse engineering construction is increased because structural components such as the existing building foundation are too close to adjacent buildings); historical and regional value data s₃ includes historical value s₃₁ (indicating the age of the existing building), regional uniqueness s₃₂ of construction techniques (indicating whether the construction techniques of the existing building have typical regional characteristics), and regional uniqueness s₃₃ of an architectural style (indicating whether the architectural style of the existing building has typical regional characteristics); urban public value data s₄ includes the building possibility s₄₁ of contributing to urban public interface construction (indicating whether one or more facades of the existing building are part of the urban public interfaces such as streets and squares), building function possibility s₄₂ of public adaptive reuse (indicating whether the use function of the existing building can be changed to the functions with public vitality such as exhibition and commerce), and landmark value s₄₃ of the building (indicating whether the existing building is already a city landmark, or has the potential to become a landmark); the value of the weight W of each index is shown in FIG. 2.

A reuse mode decision-making matrix is established to clarify the correlation between adaptability evaluation results and five reuse modes (a structure retention mode, a structure deformation mode, a component recombination mode, a material regeneration mode, and a demolition mode).

Structure retention means that when an existing structure can adapt to the demand of space variation without morphological change, the structure may be retained, and a new space demand can be met through the transformation and decoration of non-structural components.

Structure deformation means that when part of an existing structure cannot adapt to the demand of space variation, mutual adaptation between the space and the structure can be realized through the morphologic change in the local structural system or structural components, but the overall system of the structure remains unchanged.

Component recombination means that when an existing structure cannot adapt to the demand of space variation through transformation, it needs to be demolished, but the dismantled structural components can be recombined and used in the construction of other buildings as the components of new buildings, so as to adapt to the space requirements of new buildings.

Material regeneration means that when the components of the existing structure in a demolished building cannot be disassembled and reconstructed, these structural materials can be recycled, melt, and reshaped into other building materials for reuse, and used in new buildings in the form of new materials.

Demolition means that when the structures of a building to be demolished cannot be recycled as raw materials, they will be abandoned as construction waste, and the building will be demolished and cannot be reused.

The x-axis of the matrix shows the current quality data x, and the y-axis shows the reuse value data y. Either axis includes low, medium and high sections that divide a quadrant into 9 regions, and the reuse mode corresponding to each section region is as follows:
the reuse mode of a section region, corresponds to a low section of the x-axis and a low section of the y-axis, is a demolition mode;
the reuse mode of a section region, corresponds to the low section of the x-axis and a medium section of the y-axis, is a material regeneration mode;
the reuse mode of a section region, corresponds to a medium section of the x-axis and the low section of the y-axis, is a component recombination mode;
the reuse mode of each of following section regions, including a section region corresponds to the medium section of the x-axis and the medium section of the y-axis, a section region corresponds to a high section of the x-axis and the low section of the y-axis, a section region corresponds to the high section of the x-axis and the medium section of the y-axis, a section region corresponds to the low section of the x-axis and a high section of the y-axis, and a section region corresponds to the medium section of the x-axis and the high section, is structure deformation mode; and
the reuse mode of a section region, corresponds to the high section of the x-axis and the high section of the y-axis, is a structure retention mode.

According to the survey data acquired, samples P of a to-be-evaluated existing residential building are substituted into the adaptability evaluation system for quantitative evaluation to obtain the adaptability evaluation result of binary coordinates E_{P} (x_{P}, y_{P}). The computation formula is as follows:

$${x}_{p} = {s}_{P 1} + {s}_{P 2} , {y}_{p} = {s}_{P 3} + {s}_{P 4} ;$$

$${s}_{P 1} = {\sum }_{i = 1}^{5} {s}_{P l i} \cdot {W}_{P l i} , {s}_{P 2} = {\sum }_{i = 1}^{6} {s}_{P 2 i} \cdot {W}_{P 2 i} , {s}_{P 3} = {\sum }_{i = 1}^{3} {s}_{P 3 i} \cdot {W}_{P 3 i} , {s}_{P 4} = {\sum }_{i = 1}^{3} {s}_{P 4 i} \cdot {W}_{P 4 i} ,$$

where xₚ denotes the current data of a sample P; yₚ refers to the reuse value data of the sample P; s_{P1} is the maintenance status data of the sample P; s_{P2} is the structure status data of the sample P; s_{P3} is the historical and regional value data of the sample P; s_{P4} is the activation utilization value data of the sample P; s_{P1i} is the absolute value of a maintenance status evaluation factor with the serial number i, W_{P1i} is the weight value of the maintenance status evaluation factor with the serial number i; s_{P2i} is the absolute value of a structure status evaluation factor with the serial number i, W_{P2i} is the weight value of the structure status evaluation factor with the serial number i; s_{P3i} is the absolute value of a historical and regional value evaluation factor with the serial number i, W_{P3i} is the weight value of the historical and regional value evaluation factor with the serial number i; s_{P4i} is the absolute value of an adaptive reuse value evaluation factor with the serial number i, and W_{P4i} is the weight value of the adaptive reuse value evaluation factor with the serial number i; and
E_{P} (x_{P}, y_{P}) is substituted into the reuse mode decision-making matrix, and the type of the reuse mode corresponding to the region is observed so as to obtain accurate decision-making results of the reuse mode.

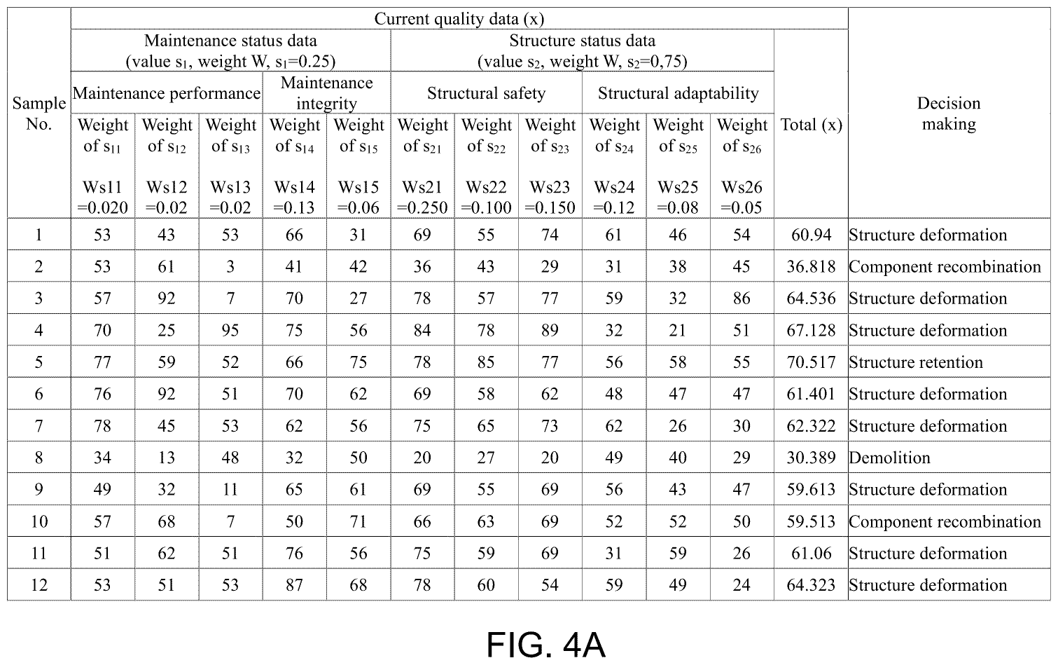

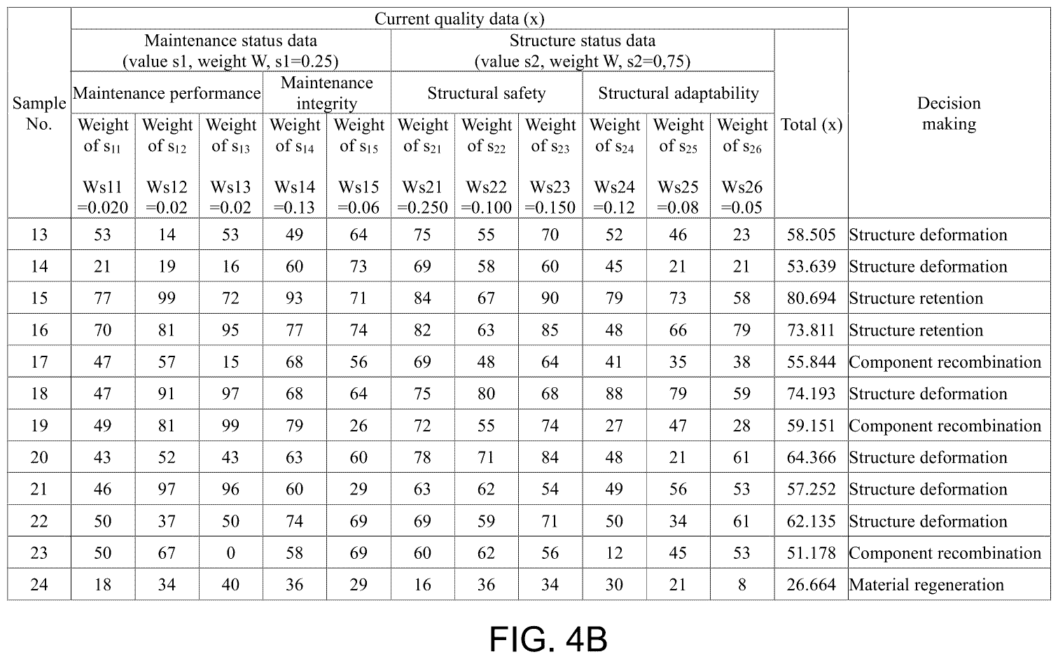

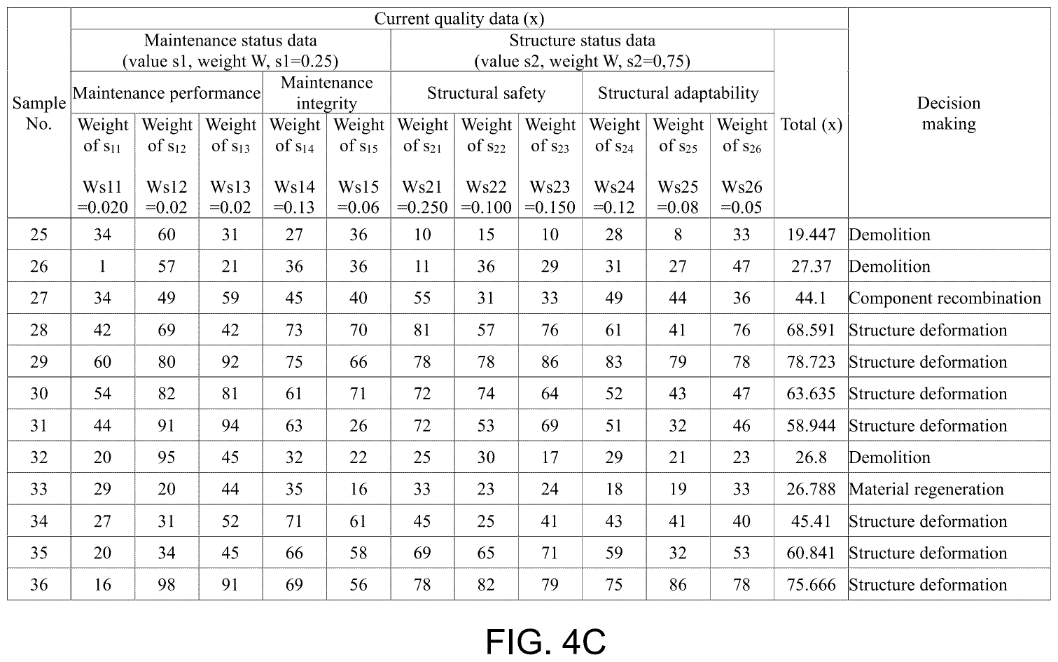

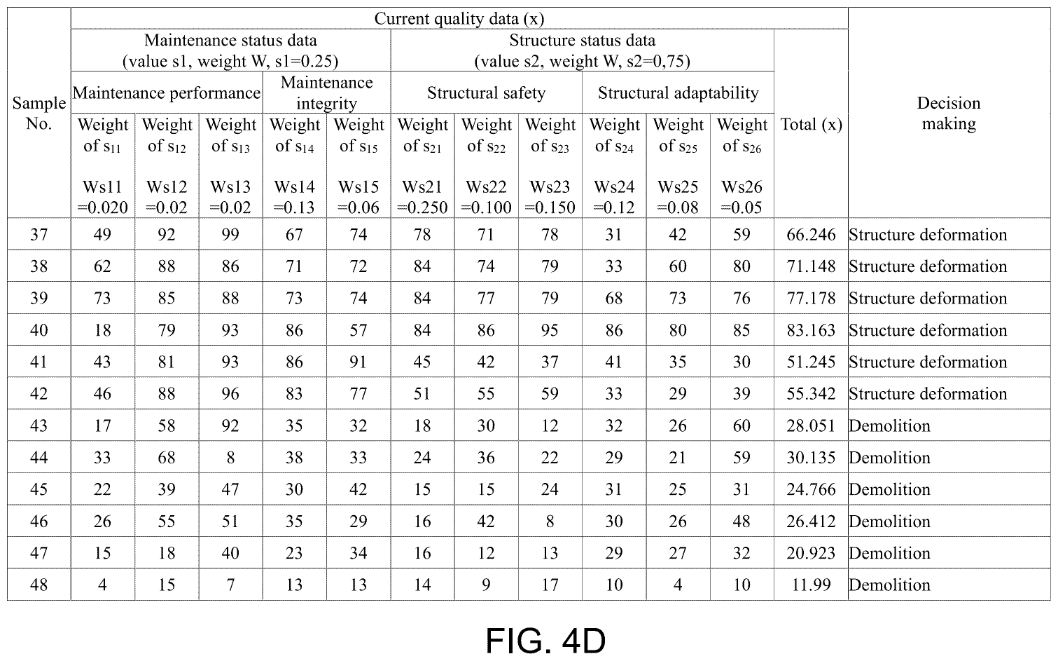

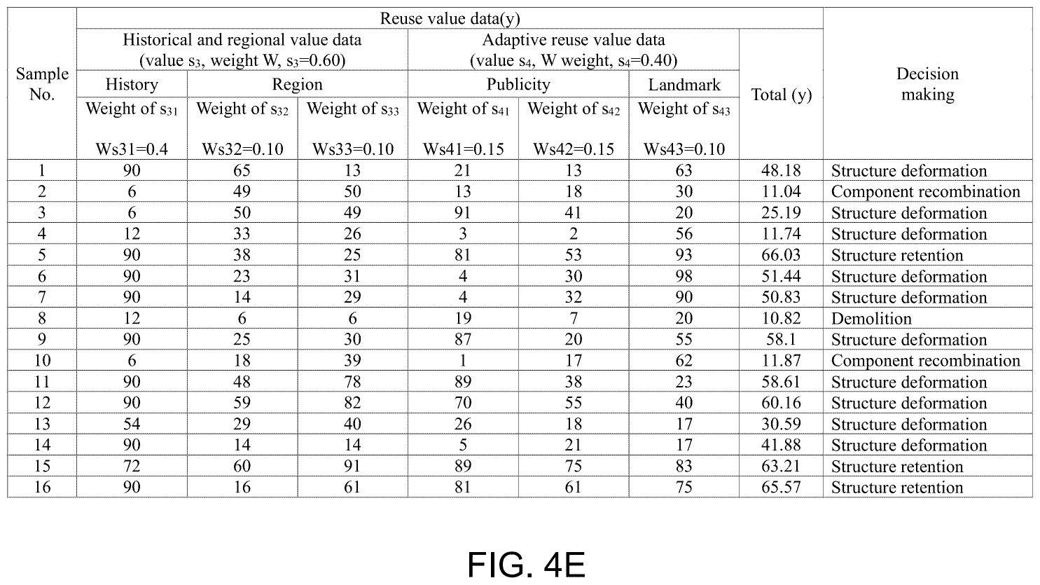

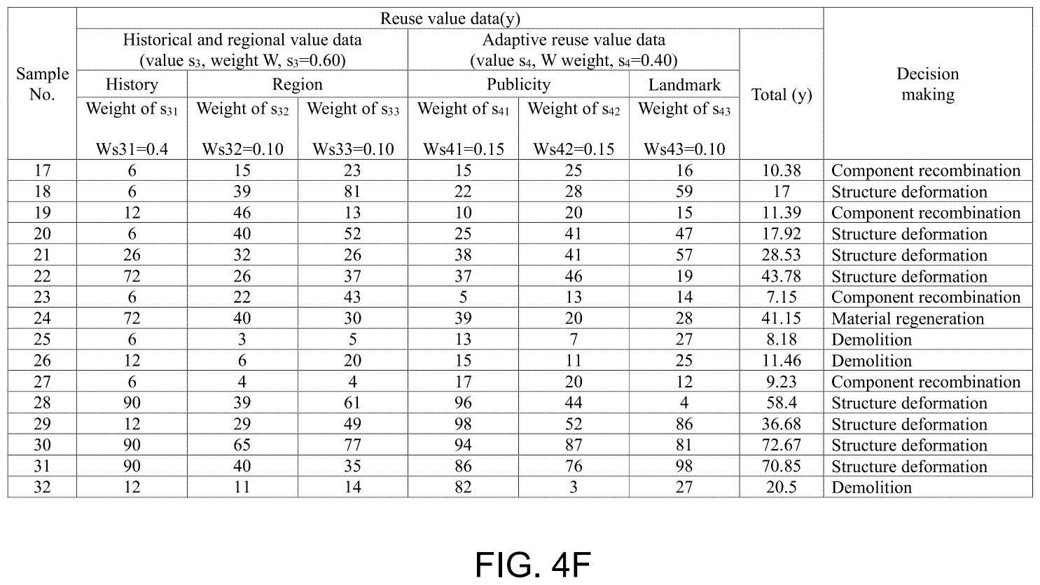

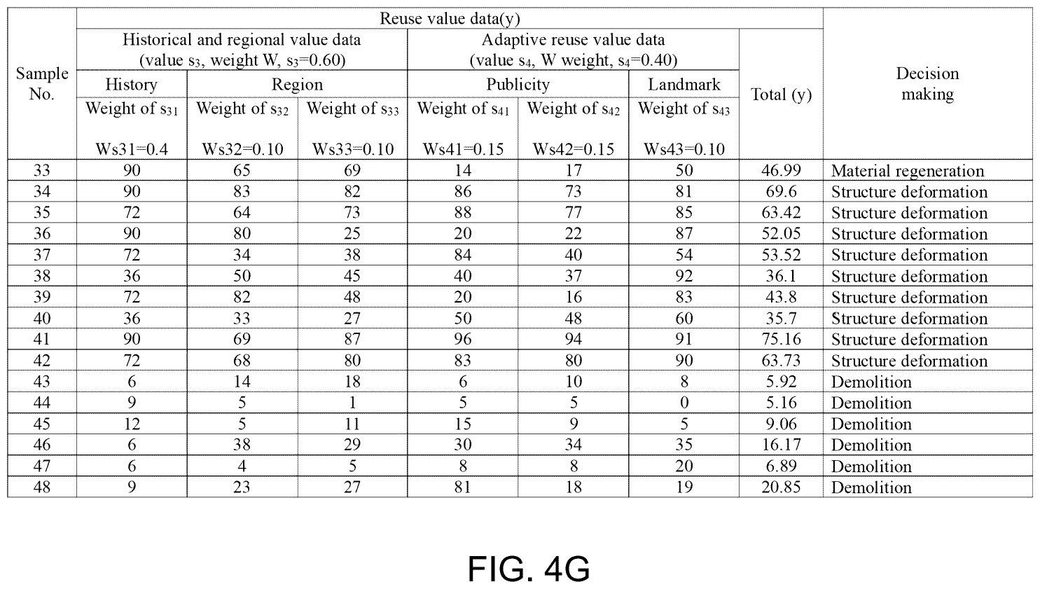

Example: 48 existing residential buildings in an urban block to be updated are selected as samples, as shown in FIGS. 4A to 4G. According to the survey data, the samples are evaluated in terms of adaptability one by one to obtain the quantitative adaptability evaluation results E_{P} (x_{P}, y_{P}) of the 48 samples, where p denotes the sample numbers 1-48.

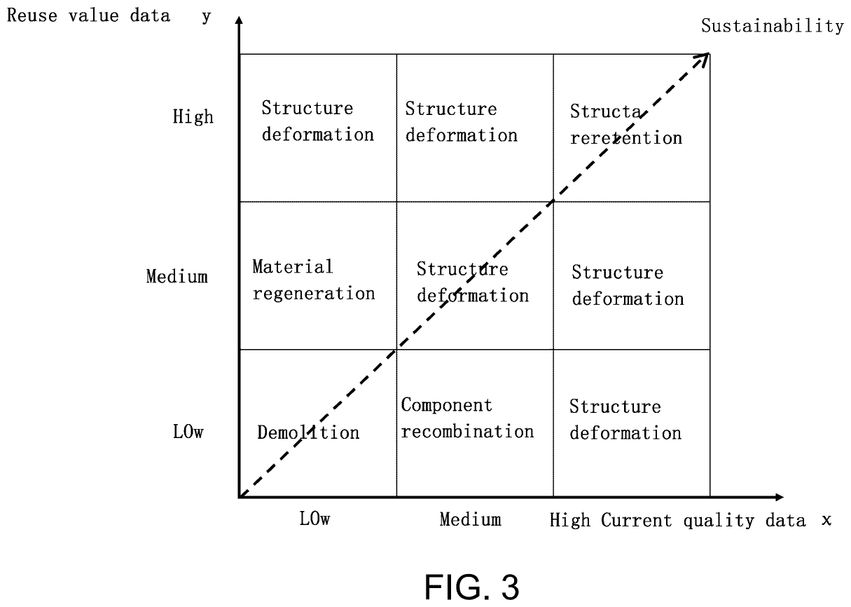

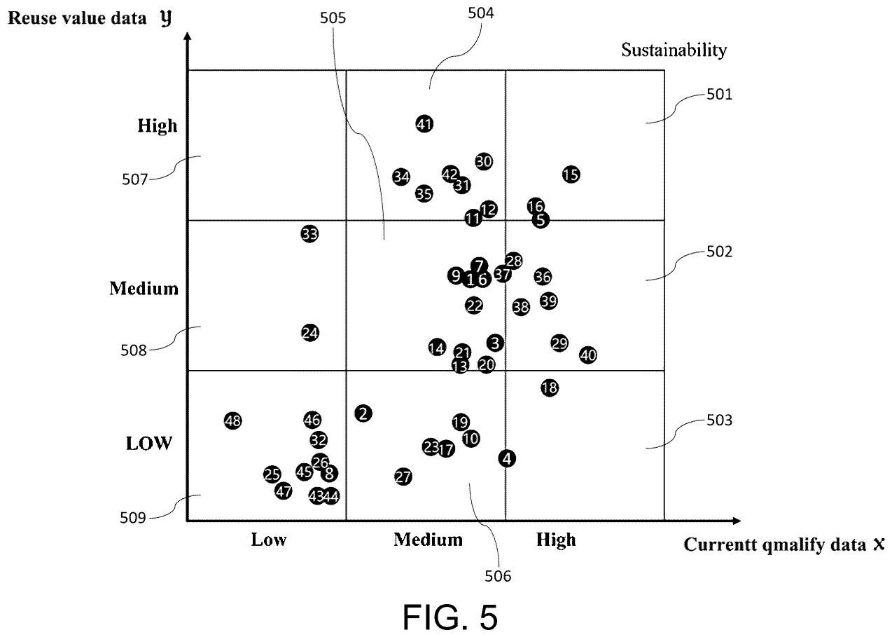

All the adaptability evaluation results E_{P} of the samples are substituted into the reuse mode decision-making matrix shown in FIG. 3 to obtain the distribution of the samples in the reuse mode decision-making matrix, as shown in FIG. 5. In FIG. 5, the region 501 of the matrix is corresponding to the structure retention mode, the regions 502, 503, 504, 505 and 507 of the matrix are corresponding to the deformation retention mode, the region 508 of the matrix is corresponding to the component recombination mode, the region 506 of the matrix corresponds to the material regeneration mode and the region 509 of the matrix is corresponding to the demolition mode. It can be seen that samples 5, 15, and 16 are located in a structure retention region of the matrix, samples 2, 4, 10, 17, 19, and 23 are located in a component recombination region of the matrix, samples 24 and 33 are located in a material regeneration region of the matrix, samples 8, 25, 26, 27, 32, 43, 44, 45, 46, 47, and 48 are located in a demolition region of the matrix, and other samples are located in a structure deformation region of the matrix.

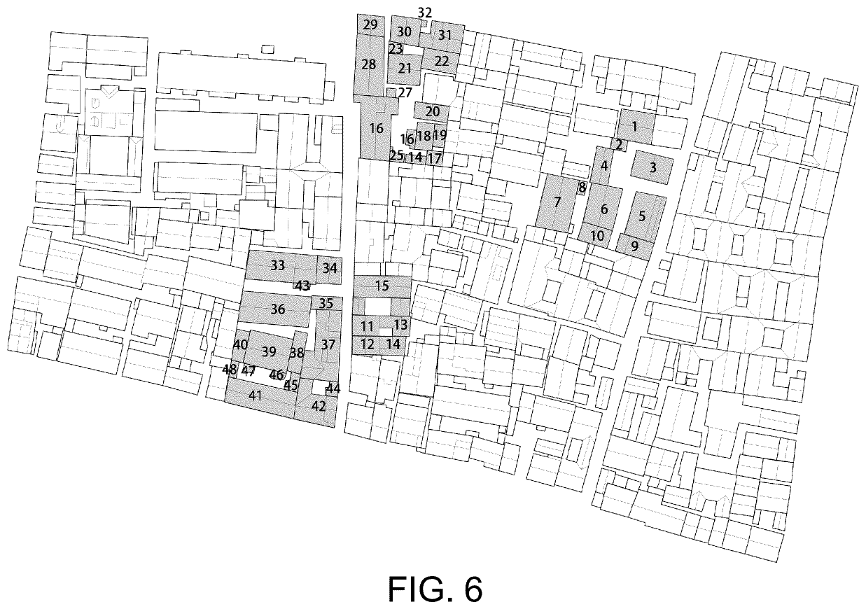

Therefore, a reasonable reuse mode decision-making conclusion of the 48 samples is drawn, as shown in FIG. 6.

An embodiment of the present invention further discloses a device for evaluating adaptive reuse of existing residential buildings. The device is configured to execute the database storage process. In the database storage process, a method for evaluating adaptive reuse of existing residential buildings disclosed in FIGS. 1-6 is implemented.

An embodiment of the present invention further discloses a computer storage medium, and the storage medium includes a database storage process, where when the database storage process is executed, the device where the storage medium is located is controlled to implement the method for evaluating adaptive reuse of existing residential buildings disclosed in FIGS. 1-6.

In the context of the present prevention, the computer storage medium may be a tangible medium that may include or store a program for use by the instruction execution system, apparatus or device or in combination with the instruction execution system, apparatus or device. A machine-readable medium may be a machine-readable signal medium or a machine-readable storage medium. The machine-readable medium may include, but is not limited to, any electronic, magnetic, optical, electromagnetic, infrared, or semi-conductive system, apparatus, or device, or any suitable combination of the above system, apparatus, or device. More specific examples of the computer-readable medium include the following: an electrical connection part having one or more wires, portable computer diskette, a hard disk, a random access memory (RAM), a read-only memory (ROM), an erasable programmable read-only memory (EPROM, or flash memory), an optical fiber device, and a portable compact disc read-only memory (CD-ROM), an optical storage device, or a magnetic storage device, or any suitable combination of the above.

The basic principles, main features and advantages of the present invention are shown and described above. It should be understood by those skilled in the art that the present invention is not limited by the foregoing embodiments, the descriptions in the foregoing embodiments and the specification are merely illustrative of the principles of the present invention, various changes and improvements will be made in the present invention without departing from the spirit and scope of the present invention, and all these changes and improvements fall within the scope of the present invention.

What is claimed is:

1. A method for evaluating adaptive reuse of existing residential buildings, comprising:
substituting research data of a to-be-evaluated residential building into an adaptability evaluation system to obtain an evaluation result, and determining a reuse mode of the to-be-evaluated residential building at a region position of a reuse mode decision-making matrix according to the evaluation result;
wherein the research data of the to-be-evaluated residential building includes current quality data and reuse value data;
the adaptability evaluation system is: xₚ=s_{P1}+s_{P2}, yₚ=s_{P3}+s_{P4};
$${s}_{P 1} = {\sum }_{i = 1}^{5} {s}_{P l i} \cdot {W}_{P l i} , {s}_{P 2} = {\sum }_{i = 1}^{6} {s}_{P 2 i} \cdot {W}_{P 2 i} , {s}_{P 3} = {\sum }_{i = 1}^{3} {s}_{P 3 i} \cdot {W}_{P 3 i} , {s}_{P 4} = {\sum }_{i = 1}^{3} {s}_{P 4 i} \cdot {W}_{P 4 i} ,$$
where xₚ denotes the current quality data of a sample P; yₚ refers to the reuse value data of the sample P; s_{P1} is maintenance status data of the sample P; s_{P2} is structure status data of the sample P; s_{P3} is historical and regional value data of the sample P; s_{P4} is activation utilization value data of the sample P; s_{P1i} is an absolute value of a maintenance status evaluation factor with a serial number i, W_{P1i} is a weight value of the maintenance status evaluation factor with the serial number i; s_{P2i} is an absolute value of a structure status evaluation factor with the serial number i, W_{P2i} is a weight value of the structure status evaluation factor with the serial number i; s_{P3i} is an absolute value of a historical and regional value evaluation factor with the serial number i, W_{P3i} is a weight value of the historical and regional value evaluation factor with the serial number i; s_{P4i} is an absolute value of an adaptive reuse value evaluation factor with the serial number i, and W_{P4i} is a weight value of the adaptive reuse value evaluation factor with the serial number i; and
each region of the reuse mode decision-making matrix corresponds to one reuse mode for the existing residential buildings; reuse modes at least include a structure retention mode, a structure deformation mode, a component recombination mode, a material regeneration mode, and a demolition mode.

2. The method for evaluating adaptive reuse of existing residential buildings according to claim 1, wherein the current quality data includes data of structural quality and maintenance quality; and the reuse value data includes the historical and regional value data and the activation utilization value data.

3. The method for evaluating adaptive reuse of existing residential buildings according to claim 2, wherein in construction of the reuse mode decision-making matrix,
x-axis shows the current quality data, and y-axis shows the reuse value data; the x-axis and the y-axis include low, medium and high sections;
the reuse mode of a section region, corresponds to a low section of the x-axis and a low section of the y-axis, is the demolition mode;
the reuse mode of a section region, corresponds to the low section of the x-axis and a medium section of the y-axis, is the material regeneration mode;
the reuse mode of a section region, corresponds to a medium section of the x-axis and the low section of the y-axis, is the component recombination mode;
the reuse mode of each of following section regions, including a section region corresponds to the medium section of the x-axis and the medium section of the y-axis, a section region corresponds to a high section of the x-axis and the low section of the y-axis, a section region corresponds to the high section of the x-axis and the medium section of the y-axis, a section region corresponds to the low section of the x-axis and a high section of the y-axis, and a section region corresponds to the medium section of the x-axis and the high section, is the structure deformation mode; and
the reuse mode of a section region, corresponds to the high section of the x-axis and the high section of the y-axis, is the structure retention mode.

4. A system for evaluating adaptive reuse of existing residential buildings, comprising the following modules:
an adaptability evaluation module, used to establish an adaptability evaluation system based on an analytic hierarchy process, with current quality data and reuse value data as indicators, and output an evaluation result of a to-be-evaluated residential building;
a reuse mode decision-making matrix module, used to form a reuse mode decision-making matrix by intersecting the reuse value data and the current quality data, wherein each region of the reuse mode decision-making matrix corresponds to one reuse mode for the existing residential buildings; and
a decision-making module, used to judge a region of the evaluation result in the reuse mode decision-making matrix, and determine a reuse mode of the to-be-evaluated residential building.

5. The system for evaluating adaptive reuse of existing residential buildings according to claim 4, wherein the current quality data includes data of structural quality and maintenance quality; and the reuse value data includes historical and regional value data and activation utilization value data.

6. The system for evaluating adaptive reuse of existing residential buildings according to claim 4, wherein reuse modes for existing residential buildings include a structure retention mode, a structure deformation mode, a component recombination mode, a material regeneration mode, and a demolition mode.

7. The system for evaluating adaptive reuse of existing residential buildings according to claim 6, wherein in construction of the reuse mode decision-making matrix,
x-axis shows the current quality data, and y-axis shows the reuse value data; the x-axis and the y-axis include low, medium and high sections;
the reuse mode of a section region, corresponds to a low section of the x-axis and a low section of the y-axis, is the demolition mode;
the reuse mode of a section region, corresponds to the low section of the x-axis and a medium section of the y-axis, is the material regeneration mode;
the reuse mode of a section region, corresponds to a medium section of the x-axis and the low section of the y-axis, is the component recombination mode;
the reuse mode of each of following section regions, including a section region corresponds to the medium section of the x-axis and the medium section of the y-axis, a section region corresponds to a high section of the x-axis and the low section of the y-axis, a section region corresponds to the high section of the x-axis and the medium section of the y-axis, a section region corresponds to the low section of the x-axis and a high section of the y-axis, and a section region corresponds to the medium section of the x-axis and the high section, is the structure deformation mode; and
the reuse mode of a section region, corresponds to the high section of the x-axis and the high section of the y-axis, is the structure retention mode.

8. A non-transitory storage medium on which a computer program is stored, wherein when the computer program is executed by a processor, the method for evaluating adaptive reuse of existing residential buildings according to claim 1 is implemented.

9. A device for evaluating adaptive reuse of existing residential buildings, comprising:
at least one memory, configured for storing a program; and
at least one processor, configured to load the program to implement the method for evaluating adaptive reuse of existing residential buildings according to claim 1.
